(19) United States
(12) Patent Application Publication
(10) Pub. No.: US 2006/0248787 A1
(43) Pub. Date: Nov. 9, 2006

(54) Enhancement of fragrance release from top of candles

(76) Inventor: Ben Warren Borchert, Syracuse, UT (US)

Correspondence Address: LYNN G. FOSTER, 602 East 300 South, Salt Lake City, UT, 84102, US

(21) Appl. No.: 11/125,034

(22) Filed: May 9, 2005

(51) Int. Cl. C11C 5/00

(52) U.S. Cl. 44/275

(57) ABSTRACT

Combinations, assemblies and methods for releasing candles and like objects to promptly flamelessly release a fragrance are disclosed, which utilize a heater disposed at least in part directly above the candle whereby heat is applied to the container.

### FIELD OF THE INVENTION

The present invention relates generally to emission of fragrance from a candle or the like and, more particularly, to novel combinations, assemblies and methods by which a normally solid candle or like item in a receptacle or container is melted by heat applied from above the candle using a heating element.

### BACKGROUND

Perfumed candles and like fragrance-releasing items in a solid state at room temperature are typically placed in a container, such as an open top glass vessel. Fragrance is emitted from the material comprising the candle or like item by either burning an exposed wick which melts the top of the candle, or externally heating the bottom of the container to Blamelessly melt to lower portions of the candle or like object.

Wick burning releases pollutants which, to some extent, mutes the perfume fragrance also being released and, with some candle compositions, can be harmful to health.

Non-uniform heating of the material from the bottom can result in an explosion, risking human injury and destroying the assembly including the container. Since heating from the bottom must change the phase of the material at the top from solid to liquid before gaseous fragrance is flamelessly released, the non-fragrance time delay between applying bottom heat and obtaining the fragrance creates impatience with many consumers.

### BRIEF SUMMARY AND OBJECTS OF THE INVENTION

In brief summary, the present invention overcomes or alleviates prior problems pertaining to the release of fragrance from and/or the melting of candles and the like. Heat is applied from above to the material from which the containerized candle or like item is made, whereby melting at the top of the material occurs promptly resulting in a much faster flameless release of fragrance from the material.

With the foregoing in mind, it is a primary object to overcome or alleviate problems of the past pertaining to release of fragrance from and/or the melting of candles and like items.

Another valuable object is the provision of novel combinations or assemblies and unique methods for releasing fragrance from and/or melting candles and like items by applying flameless heat to the top of the candles and like items.

A further paramount object is the provision of novel combinations, assemblies and method utilizing an elevated flameless heat source to promptly melt the top of a containerized candle or like item thereby rapidly flamelessly releasing fragrance.

These and other objects and features of the present invention will be apparent from the detailed description taken with reference to accompanying drawings.

### BRIEF DESCRIPTION OF THE DRAWINGS

FIG. 1 is a schematic of a system according to the present invention for quickly melting the top of a candle or like item to provoke promptly release of fragrance;

FIG. 2 is a schematic of another system according to the present invention similar to FIG. 1 but comprising a fragrance displacing fan; and

FIGS. 3 through 5 are elevations with parts broken away depicting various types of heating elements for melting the candle material from the top down.

### DETAILED DESCRIPTION OF THE ILLUSTRATED EMBODIMENTS

Reference is now made to the drawing wherein like numerals are used to designate like parts throughout. The present invention relates generally to emission of fragrance from a material used to form candles or like objects and comprises combinations, assemblies and methods by which a top region of a normally solid candle or like object in a receptacle, vessel or container is melted, without combustion, by heat applied from above directly to the material comprising the candle. While the elevated source of heat may be spaced from the top of the candle-forming material, in the alternative a heating element may be on or embedded in the material which promptly melts the top of the material.

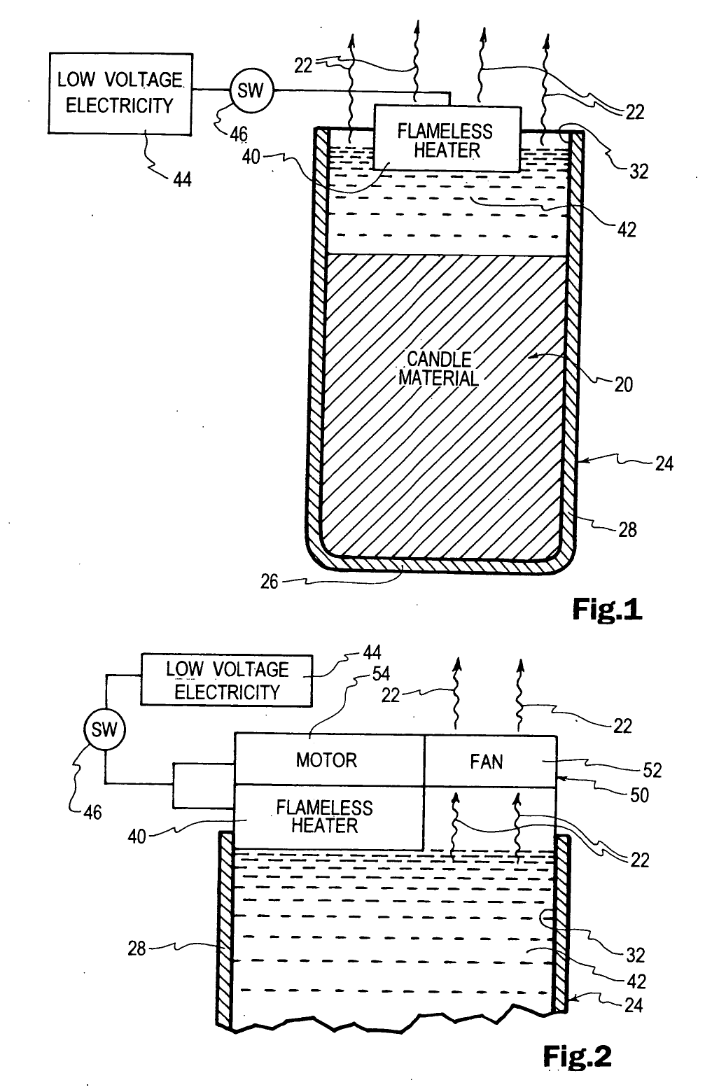

Typically, the vessel is formed as one piece and comprised of glass so that the material from which the candle is made is visually observable through the vessel. Fragrance emission is due to top melting. Because candle burning producing emissions of combustion, ordinarily in confined locations, such as homes, it is preferred that top melting alone, without combustion, be the mode by which fragrance 22 (FIG. 1) is emitted. In this way, the fragrance is promptly made available without potentially harmful releases of pollutants due to combustion, also eliminating the risk of fire caused by a burning candle.

Any source of low voltage heat may be utilized to first melt the top region of the candle or like object in the vessel. When the fragrance is no longer desired, the user simply shuts the elevated heater off, allowing the material from which the candle or like object is formed to return from a liquid state to a solid state. While the fragrance emission technique of the present invention may utilize a candle with a wick because of ready availability, there is no absolute requirement that the object to be melted be a candle per se nor that a wick be part of the object melted.

There is no constraint on the type of fragrance to be emitted, nor on the shape of the vessel, candle or heat-conductive core or element embedded in the material of which the candle or like object is comprised. The present invention embraces any suitable way of heating and melting the top region of the aroma-emitting material within the vessel.

Attention is directed to FIG. 1, which schematically illustrates a pre-existing solid quantity of candle material, generally designated 20, encased by or confined in a vessel or container, generally designated 24. The vessel 24 is illustrated as being formed as one piece so as to comprise a bottom wall 26, a hollow cylindrical side wall 28, and an opening 32 through which fragrance from the perfumed material 20 escapes from the vessel 24 upon the application of heat to the top region of the material 20. Low voltage electricity 44 may be a battery or transformed from 110 volt household electricity, which low voltage electricity is communicated to the heater 40 across an on-off switch 46.

Heretofore, the process of melting the material 34 has been slow and non-uniform, because heat was applied through the bottom 26 of the vessel 24 to the material 20. To address this problem, the present invention utilizes a heat source, generally designated 40, which promptly melts or liquefies the top region 42 of the material 20. Any suitable heater 40 may be used. The heater 40, with switch 46 on, may emit heat directly onto the top region 42 so as to not require physical contact between a heating element and the top region 42 of the material 20, which lowers over time due to consumption of the material 20. The heater 40 may comprise a heating element which is and remains contiguous with the top region 42.

As shown in FIG. 2, the heater 40 may be disposed in a pervious lid 50, releasibly press-fit into the top opening 32 of the vessel 24. Lid 50 is also shown as containing a fan 52, driven by a motor 54, which displaces the released aroma or fragrance 22 through the pervious lid 52 to the surrounding ambient environment. The exterior 54 of the lid 50 may display indicia, including but not limited to advertising.

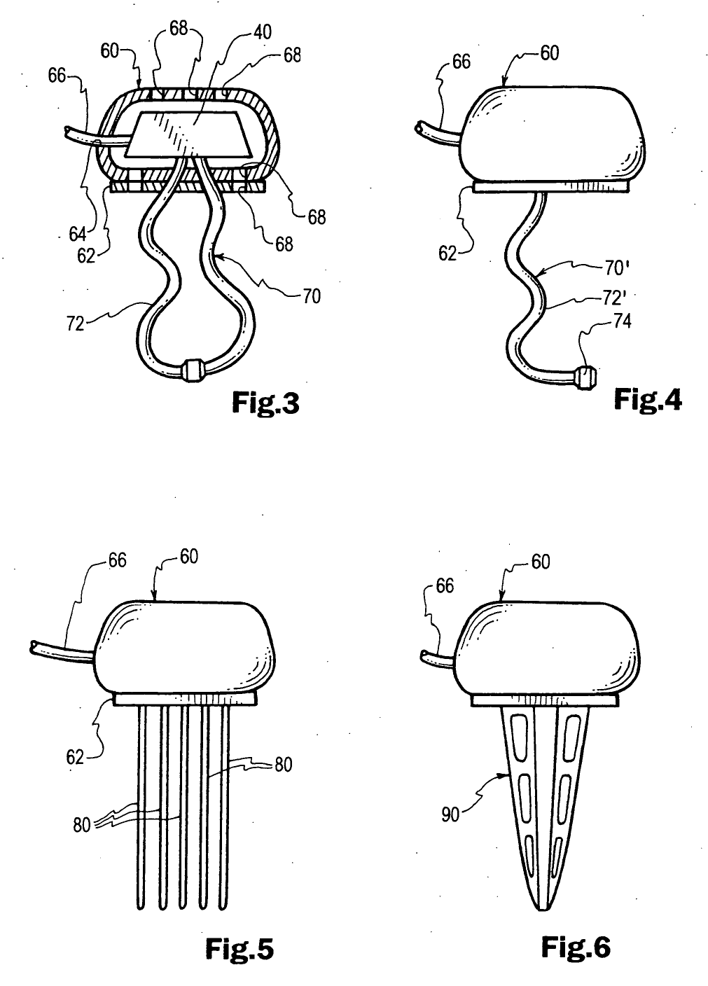

FIG. 3 illustrates a pervious lid 60, to be releasibly press-fit into opening 32 of the container 24 at a base 62. The lid 60 comprises an aperture 64 in one side of the lid 60 through which a conductor 66 communicates low voltage electricity to heater 40, encased in the lid 60. Apertures 68 in the lid 60 and base 62 accommodate flow of fragrance to the surrounding ambient environment. The heater 40 comprises a heating element, generally designated 70, in the form of an endless loop melting cable 72, which rests, prior to activation, on the solid top surface of the material 20, and, upon activation melts the top region 42 and lowers, due to gravity, into the melted material.

FIG. 4 illustrates use, in conjunction with lid 60, of second form of heating element, generally designated 70′, in the form of a length of melting cable 72′ having a distal end 74. Melting cable 72′ functions to first rest upon and, when energized, to melt the top region of the material in the vessel 24, sinking into the material, due to gravity, as the material melts.

As shown in FIG. 5, in lieu of either melting cable 72 or 72′, a plurality of heating element probes 80 may be used. Probes 80 are initially forced into the solid material 20 in the vessel 24 as the base 62 of the lid 60 is inserted into the top opening 32 of the vessel. The inserted probes 80, when electrically energized, will melt the material 20 from the top down. The length of the probes takes into account that the material 20 is consumable. Therefore, the top surface of the material 20 lowers over time.

As shown in FIG. 6, in lieu of rod-like probes 80, other forms of heating probes, such as pointed piercing-heating element 90, may be used in conjunction with heater 40 and lid 60 to heat from the top down. Heating element 90 functions essentially the same as probes 80.

The invention may be embodied in other specific forms without departing from the spirit of the central characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A combination comprising:
a container;
a fragrance releasing material disposed in the container, the material comprising a top and being solid at room temperature but having a low melting point;
a flameless heater superimposed over the material in the container by which the material is melted at the top thereof to more rapidly release fragrance.

2. A combination according to claim 1 wherein the flameless heater comprises a heating element contiguous with the material.

3. A combination according to claim 2 wherein the heating element is selected from the group consisting of heating elements which rest at least in part contiguously on the top surface of the material and heating elements which are at least in part embedded into the material from the top.

4. A combination according to claim 1 wherein the heater at least in part is disposed in a lid superimposed.

5. A combination according to claim 4 wherein the lid is pervious to fragrance discharge from the container through the lid.

6. A combination according to claim 5 further comprising a fan carried by the lid for fragrance discharge through at least one aperture in the lid.

7. A fragrance releasing combination comprising;
a vessel;
a quantity of fragrance-bearing material, comprising a top, disposed in the vessel, the state of which is transformed from solid to liquid upon the application of flameless heat at the top of the material;
an element positioned above the material within the vessel by which the flameless heat melts the material from the top down to more rapidly emit fragrance.

8. A fragrance emitting assembly comprising:
a candle comprised of wax-like fragrance-containing material which is in a solid state at room temperature;
an impervious encasement containing the material;
a heat conductive element disposed at least in part above the material of which the candle is comprised;
whereby application of heat by the element to a top region of the candle within the encasement, the element directly melting the top region without communicating heat through the encasement causing more rapid release of the fragrance from the material.

9. A method of releasing a fragrance from a normally solid fragrance bearing material disposed in a receptacle, comprising the acts of:
disposing a source of heat at least in part above the material within the receptacle;
applying heat from the source direct on a top region of the material with communication through the vessel for prompt emission of fragrance.

10. A method of emitting a fragrance comprising the acts of:
transforming a top region of a solid material in a container to a liquid at the top region causing more rapid release of a fragrant odor by application of heat directly to the top region of the material.

11. A method of melting a candle without combustion, comprising the acts:
combining a heater, a candle, with or without a wick and a container in which the candle is disposed;
directly and flamelessly heating the candle at the top thereof from the heater with heat to promptly melt the candle at the top thereof;
flamelessly permitting fragrance from the melted top of the candle to the adjacent ambient environment.
